(19) United States
(12) Patent Application Publication
(10) Pub. No.: US 2013/0264462 A1
(43) Pub. Date: Oct. 10, 2013

(54) OPTICAL TOUCH APPARATUS AND OPTICAL SENSOR MODULE THEREOF

(71) Applicants: YU-HSIANG HUANG, Hsinchu (TW); Chun-Yi Lu, Hsinchu (TW); Chun-Sheng Lin, Hsinchu (TW)

(72) Inventors: YU-HSIANG HUANG, Hsinchu (TW); Chun-Yi Lu, Hsinchu (TW); Chun-Sheng Lin, Hsinchu (TW)

(73) Assignee: PixArt Imaging Inc., Hsinchu City (TW)

(21) Appl. No.: 13/589,087

(22) Filed: Aug. 17, 2012

(30) Foreign Application Priority Data
Apr. 10, 2012 (TW) 101112668

(51) Int. Cl. G01J 1/04

(52) U.S. Cl. 250/206.1

(57) ABSTRACT

An optical touch apparatus includes a sensing region, a first and a second light emitting assemblies and a first and a second light sensor devices. The first and second light emitting assemblies are disposed in an edge of the sensing region. The first and second light emitting assemblies include a light emitting device and an optical cover including a light incidence, light emission and reflection parts, which defines a space for accommodating the light emitting device. The light from the light emitting device is emitted into and out from the optical cover sequentially through the light incidence and emission parts. The reflection part is connected between the light incidence and emission parts and for reflecting the light from the light emitting device. The first and second light sensor devices overlay the light emitting devices of the first and second light emitting assemblies, respectively. An optical sensor module is also provided.

### TECHNICAL FIELD

The present invention relates to a touch apparatus and a sensor module thereof, and more particularly to an optical touch apparatus and an optical sensor module thereof.

### BACKGROUND

FIG. 1 is a schematic structural view of a conventional optical touch apparatus equipped with three light sensor devices. As shown, the conventional optical touch apparatus 100 includes four reflective strips 112a, 112b, 112c and 112d corporately forming a rectangle. The optical touch apparatus 100 further includes light emitting devices 122a, 122b configured to provide light to the reflective strips 112a, 112b, 112c and 112d. Specifically, the light emitting device 122a is disposed between the two adjacent reflective strips 112a, 112b, and the light emitting device 122b is disposed between the two adjacent reflective strips 112c, 112d. The reflective strips 112a, 112b, 112c and 112d each are configured to reflect the light provided from either the light emitting device 122a or the light emitting device 122b. In addition, the optical touch apparatus 100 further includes light sensor devices 132a, 132b and 132c. Specifically, the light sensor device 132a is disposed between the two adjacent reflective strips 112a, 112b; and the light emitting device 122a is disposed on the light sensor device 132a. The light sensor device 132b is disposed between the two adjacent reflective strips 112b, 112c. The light sensor device 132c is disposed between the two adjacent reflective strips 112c, 112d; and the light emitting device 122b is disposed on the light sensor device 132c.

The light emitting device 122a is emitting light while the light sensor device 132a is performing a light sensing operation. However, the pixels in the light sensor device 132a, due to the light emitted from the light emitting device 122a cannot be reflected back by the light sensor device 132c, may sense a distorted luminance as illustrated in FIG. 2. As shown, a dark area (indicated by dotted line D) is resulted in due to the light sensor device 132c cannot reflect the light emitted from the light emitting device 122a; and consequently, the dark area may be determined as a user's touch operation. Based on the same manner, it is to be noted that the light sensor device 132c may also have the same aforementioned issue while performing the light sensing operation.

Conventionally, the aforementioned issue can be prevented from occurring through configuring the light emitting device 122b to emit light simultaneously with the light emitting device 122a; however, some side effects may be consequently brought in. For example, because both the light emitting devices 122a, 122b are emitting light while the light sensor device 132a is performing the light sensing operation, some pixels (specifically, corresponding the light sensor device 132c) of the light sensor device 132a may sense another distorted luminance as illustrated in FIG. 3. As shown, the light emitted from the light emitting device 122b may generate a peak P1. In addition, because the light emitting device 122b basically is configured to have a relatively small emitting region, two dark areas accordingly occur on both sides of the peak P1. Because each having a relatively large width, the two dark areas may be determined as a user's touch operation; in other words, the positions of the two dark areas may be erroneously determined as two touch position.

### SUMMARY OF EMBODIMENTS

Therefore, one object of the present invention is to provide an optical touch apparatus so as to reduce the probability of erroneous touch position determinations.

Another object of the present invention is to provide an optical sensor module, applicable to an optical touch apparatus, so as to reduce the probability of erroneous touch position determinations in the optical touch apparatus.

The present invention provides an optical touch apparatus, which includes a sensing region, a first light emitting assembly, a second light emitting assembly, a first light sensor device and a second light sensor device. The first light emitting assembly is disposed in an edge area of the sensing region. The second light emitting assembly is disposed in an edge area of the sensing region. The first and the second light emitting assemblies each include a light emitting device and an optical cover. The optical cover includes a light incidence part, a light emission part and a reflection part. An accommodation space is defined by the light incidence part and configured to accommodate the light emitting device. The light provided by the light emitting device is sequentially emitted into the optical cover through the light incidence part thereof and emitted out from the optical cover through the light emission part thereof. The reflection part is disposed between the light incidence part and the light emission part and configured to reflect a portion of the light provided by the light emitting device. The first light sensor device is arranged to overlay the light emitting device of the first light emitting assembly. The second light sensor device is arranged to overlay the light emitting device of the second light emitting assembly.

In an embodiment of the present invention, the light incidence part has one first surface and two second surfaces. The second surfaces are arranged to be opposite to each other and both are connected to the first surface. The light emission part has one third surface, arranged to be opposite to the first surface, and two fourth surfaces, arranged to be opposite to the two second surfaces respectively, and the two fourth surfaces each are connected to the third surface. The reflection part has two reflective surfaces and each is connected between its associated second surface and the fourth surface.

In an embodiment of the present invention, the second and the fourth surfaces are parallel to each other, the second surface is perpendicular to the first surface, the fourth surface is perpendicular to the third surface, the reflective surfaces each and its connected second surface are arranged to have an acute angle therebetween.

In an embodiment of the present invention, the reflective surfaces each are a curved surface.

In an embodiment of the present invention, the optical cover further includes a reflective material coated on the fourth surfaces.

In an embodiment of the present invention, the light incidence part and the light emission part each have a curved surface.

In an embodiment of the present invention, the optical cover of the first light emitting assembly is further arranged to cover the first light sensor device, the optical cover of the second light emitting assembly is further arranged to cover the second light sensor device.

In an embodiment of the present invention, the first light emitting assembly is disposed at a first corner of the sensing region, the second light emitting assembly is disposed at a second corner of the sensing region, and the first and the second corners are located on a same diagonal line of the sensing region.

In an embodiment of the present invention, the aforementioned optical touch apparatus further includes a third light sensor device disposed at a third corner of the sensing region.

In an embodiment of the present invention, the sensing region includes a plurality of reflective strips corporately forming a plurality of sides of the sensing region. The first and the second light emitting assemblies each are disposed in a gap formed between two adjacent reflective strips.

In an embodiment of the present invention, the sensing region includes a plurality of light guide strips corporately forming a plurality of sides of the sensing region. The first and the second light emitting assemblies each are disposed in a gap formed between two adjacent light guide strips. Each light guide strip has a light incidence surface and a light emission surface, the light incidence surface and the light emission surface are arranged to be adjacent to each other and the light emission surface is arranged to face to the sensing region. In addition, the aforementioned optical touch apparatus further includes a light source assembly configured to provide the light emitted into the light guide strips through the light incidence surfaces thereof.

In an embodiment of the present invention, the first light emitting assembly is disposed at a first corner of the sensing region; the second light emitting assembly is disposed at a side of the sensing region not adjacent to the first corner. In addition, the aforementioned optical touch apparatus further includes a third light emitting assembly and a third light sensor device. The third light emitting assembly is disposed at a second corner of the sensing region, wherein the first and the second corners are located at two ends of a same side of the sensing region respectively. The third light emitting assembly has a structure same as that of the first light emitting assembly. The third light sensor device is arranged to overlay the light emitting device of the third light emitting assembly.

In an embodiment of the present invention, the aforementioned optical touch apparatus further includes a substrate, on which the sensing region is disposed.

In an embodiment of the present invention, the substrate is a display panel.

The present invention provides an optical sensor nodule applicable to an optical touch apparatus. The optical sensor nodule includes a light emitting assembly and a light sensor device. The light emitting assembly includes a light emitting device and an optical cover. The optical cover includes a light incidence part, a light emission part and a reflection part. An accommodation space is defined by the light incidence part and configured to accommodate the light emitting device. The light provided by the light emitting device is sequentially emitted into the optical cover through the light incidence part thereof and emitted out from the optical cover through the light emission part thereof. The reflection part is connected between the light incidence part and the light emission part and configured to reflect a portion of the light provided by the light emitting device. The light sensor device is arranged to overlay the light emitting device.

Summarily, in the optical sensor module according to the present invention, because an optical cover is arranged in a light emitting assembly and the optical cover includes a reflection part, not only the light having a relatively small light emission angle can be directly emitted into a sensing region, the light L having a relatively large light emission angle can also be reflected into the sensing region through the reflection part and thereby being sensed by a light sensor device. As thus, even the compensated light may result in peaks and dark areas, the dark areas can be modulated to have a reduced width so as to be prevented from being determined as a user's touch operation. Therefore, the optical touch apparatus of the present invention can effectively reduce the probability of erroneous touch position determinations.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic structural view of a conventional optical touch apparatus equipped with three light sensor devices;

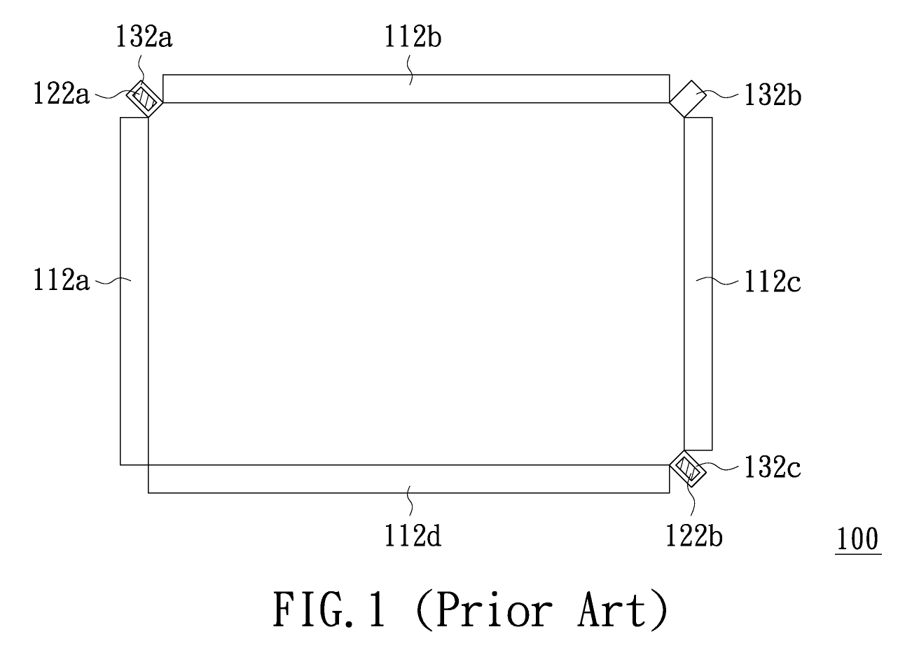

FIG. 2 is a schematic view illustrating the luminance sensed by the pixels in the light sensor device in FIG. 1;

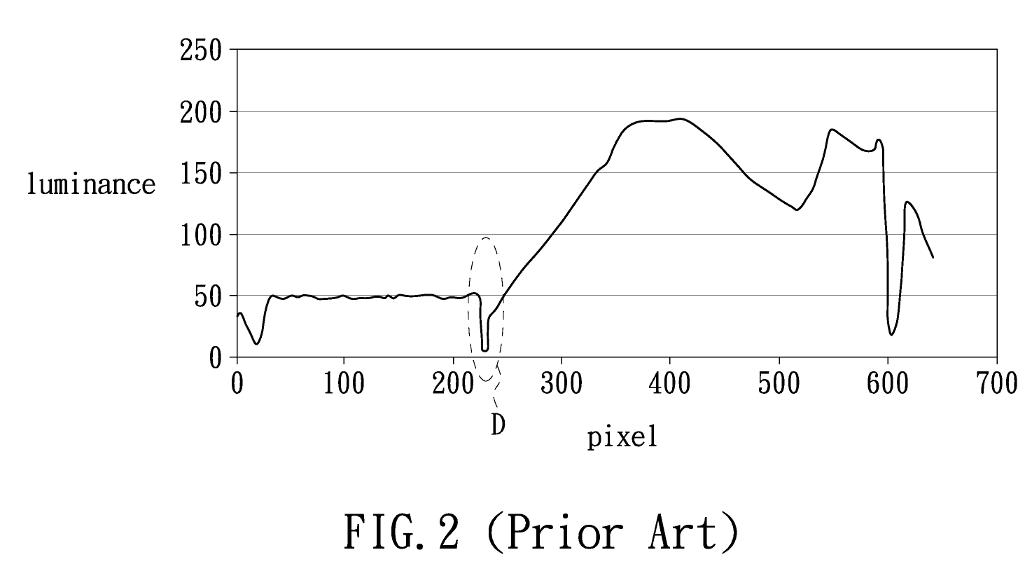

FIG. 3 is a schematic view illustrating the luminance sensed by a portion of pixels in the light sensor device in FIG. 1;

FIG. 4 is a schematic structural view of an optical touch apparatus in accordance with an embodiment of the present invention;

FIG. 5 is a schematic top view of the light emitting assembly in FIG. 4;

FIG. 6 is a schematic view illustrating the luminance sensed by a portion of pixels in the light sensor device in FIG. 4;

FIG. 7 is a schematic top view of a light emitting assembly in accordance with another embodiment;

FIG. 8 is a schematic view illustrating the luminance sensed by a portion of pixels in a light sensor device in accordance with another embodiment;

FIG. 9 is a schematic structural view of an optical touch apparatus in accordance with another embodiment of the present invention; and

FIG. 10 is a schematic structural view of an optical touch apparatus in accordance with another embodiment of the present invention.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

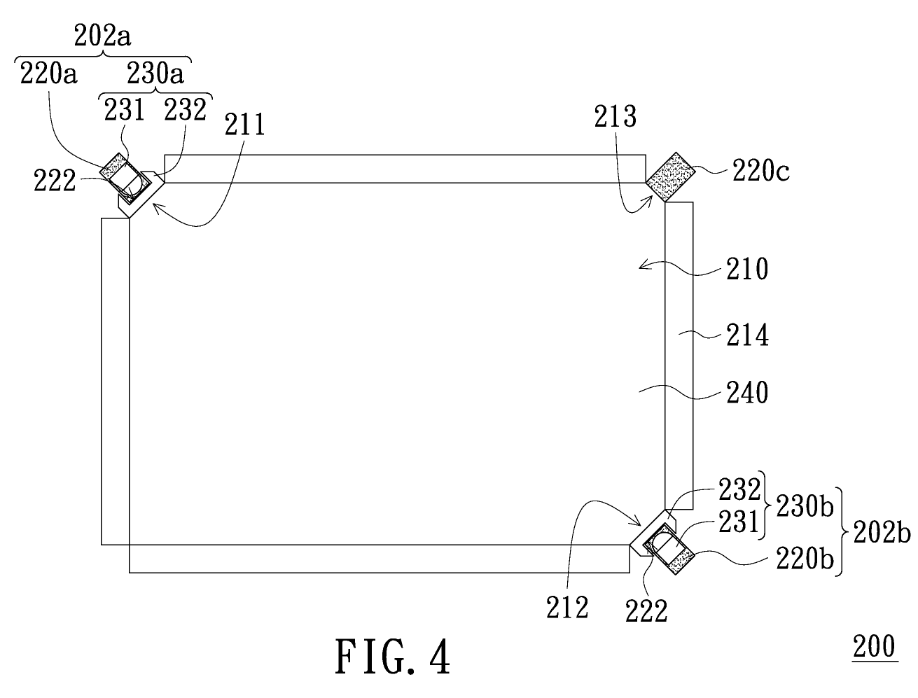

FIG. 4 is a schematic structural view of an optical touch apparatus in accordance with an embodiment of the present invention. As shown, the optical touch apparatus 200 in this embodiment includes a sensing region 210 and two optical sensor modules 202a, 202b. The optical sensor module 202a includes a light sensor device 220a and a light emitting assembly 230a; and the optical sensor module 202b includes a light sensor device 220b and a light emitting assembly 230b. The two optical sensor modules 202a, 202b each are disposed in an edge area of the sensing area 210. Specifically, the light sensor device 220a and the light emitting assembly 230a are, for example, disposed at a corner 211 of the sensing region 210; and the light sensor device 220b and the light emitting assembly 230b are, for example, disposed at another corner 212 of the sensing region 210. The sensing region 210 in this embodiment is, for example, rectangularity and the corners 211, 212 are located on a same diagonal line of the sensing region 210. In addition, the sensing area 210 includes four reflective strips 214 corporately forming the four sides of the sensing region 210. The corner 211 herein is defined as a gap formed between two adjacent reflective strips 214, and the corner 212 herein is defined as a gap formed between another two adjacent reflective strips 214. Accordingly, the light emitting assemblies 230a, 230b each are disposed in a gap formed between two adjacent reflective strips 214.

The light sensor devices 220a, 220b each can be implemented by a complementary metal-oxide-semiconductor image sensor (CMOS image sensor), a charge coupled device or other types of device configured to sense light. In addition, the optical touch apparatus of the present invention is not limited to two light sensor devices; in other words, the optical touch apparatus in the present invention may include more than two light sensor devices. For example, as illustrated in FIG. 4, the optical touch apparatus 200 may further include a light sensor device 220c disposed at a corner 213 of the sensing region 210. In addition, the optical touch apparatus 200 may further include a substrate 240, on which the sensing region 210 is disposed. In this embodiment, the substrate 240 can be a glass substrate or a plastic substrate in this embodiment; however, in another embodiment the substrate 240 can be a display panel. In addition, the reflective strips 214, the light sensor devices 220a, 220b, and 220c and the light emitting assemblies 230a, 230b can be supported directly by the substrate 240, or supported by a support frame (not shown) disposed beside the substrate 240.

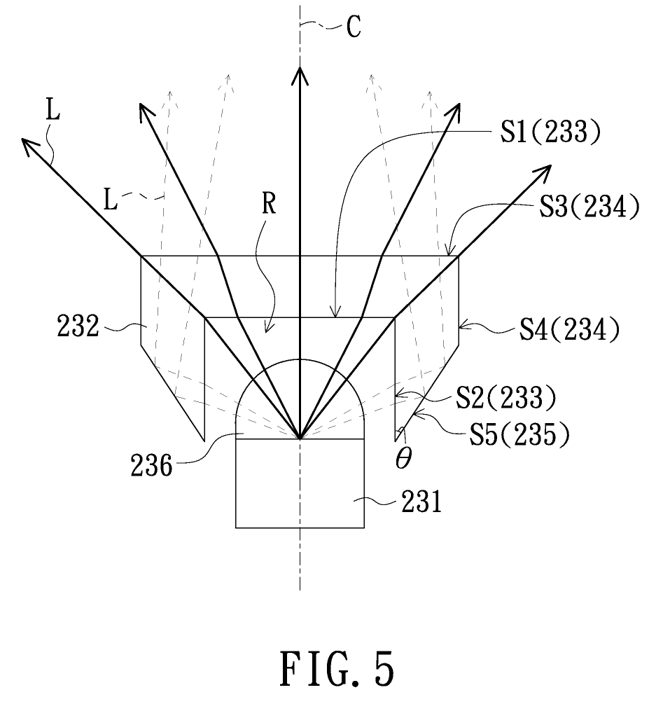

FIG. 5 is a schematic top view of the light emitting assembly in FIG. 4. Please refer to FIGS. 4, 5 both. The light emitting assemblies 230a, 230b each include a light emitting device 231 and an optical cover 232. Specifically, the light emitting device 231 of the light emitting assembly 230a and the light sensor device 220a are arranged to overlay to each other; and the light emitting device 231 of the light emitting assembly 230b and the light sensor device 220b are arranged to overlay to each other. In this embodiment, the light emitting device 231 of the light emitting assembly 230a is, for example, disposed on the light sensor device 220a; and the light emitting device 231 of the light emitting assembly 230b is, for example, disposed on the light sensor device 220b.

The optical cover 232 includes a light incidence part 233, a light emission part 234 and a reflection part 235. An accommodation space R is defined by the light incidence part 233 and configured to accommodate the light emitting device 231. In this embodiment, the light emitting device 231 is, for example, a light emitting diode or other types of semiconductor light emitting device; and no limitation. The light emitting device 231 includes a lens part 236, and one surface of the lens part 236 is referred to as a light emission surface of the light emitting device 231. In this embodiment, only the lens part 236 is accommodated in the accommodation space R; in another embodiment, the light emitting device 231 is completely accommodated in the accommodation space R. Additionally, in one embodiment, the optical cover 232 of the light emitting assembly 230a is further configured to cover a light sensing surface 222 of the light sensor device 220a; wherein the light sensing surface 222 of the light sensor device 220a is arranged to face to the sensing region 210. Based on the same manner, the optical cover 232 of the light emitting assembly 230b is further configured to cover the light sensing surface 222 of the light sensor device 220b; wherein the light sensing surface 222 of the light sensor device 220b is arranged to face to the sensing region 210.

In this embodiment, the light incidence part 233 has one surface S1 and two surfaces S2; wherein the two surfaces S2 are arranged to face to each other and the surface S1 is connected therebetween. The light emission part 234 has one surface S3 and two surfaces S4; wherein the surface S3 is opposite to the surface S1, the two surfaces S4 each are opposite to its associated surface S2, and the surface S3 is connected between the two surfaces S4. The reflection part 235 has two reflective surfaces S5, and each is connected between its associated surfaces S2, S4. In addition, the reflective surface S5 is, for example, a plane; the surfaces S2, S4 are, for example, parallel to each other; the surface S2 is, for example, perpendicular to the surface S1; and the surface S4 is, for example, perpendicular to the surface S3. In addition, each reflective surface S5 and its associated surface S2 are arranged to have an acute angle θ therebetween.

In the optical touch apparatus 200 according to this embodiment, the light L provided by the light emitting device 231 is sequentially emitted into the optical cover 232 through the light incidence part 233 thereof, emitted out from the optical cover 232 through the light emission part 234 thereof, and then emitted into the sensing region 210. In this embodiment, the light emitting assembly 230a is, while the light sensor device 220a is performing a light sensing operation, configured to emit light, and the light emitted from the light emitting assembly 230a will be reflected by the reflective strips 214. In addition, due to the light emitted from the light emitting assembly 230a cannot be reflected back by the corner 212 which is disposed with the light sensor device 220b and the light emitting assembly 230b, the light emitting assembly 230b is also configured to emit light simultaneously with the light emitting assembly 230a. Therefore, through configuring the light emitting assembly 230b to emit light simultaneously with the light emitting assembly 230a, the optical touch apparatus 200 in this embodiment can be prevented from having an erroneous determination of touch positions, which is resulted from the corner 212 unable to reflect the light emitted from the light emitting assembly 230a.

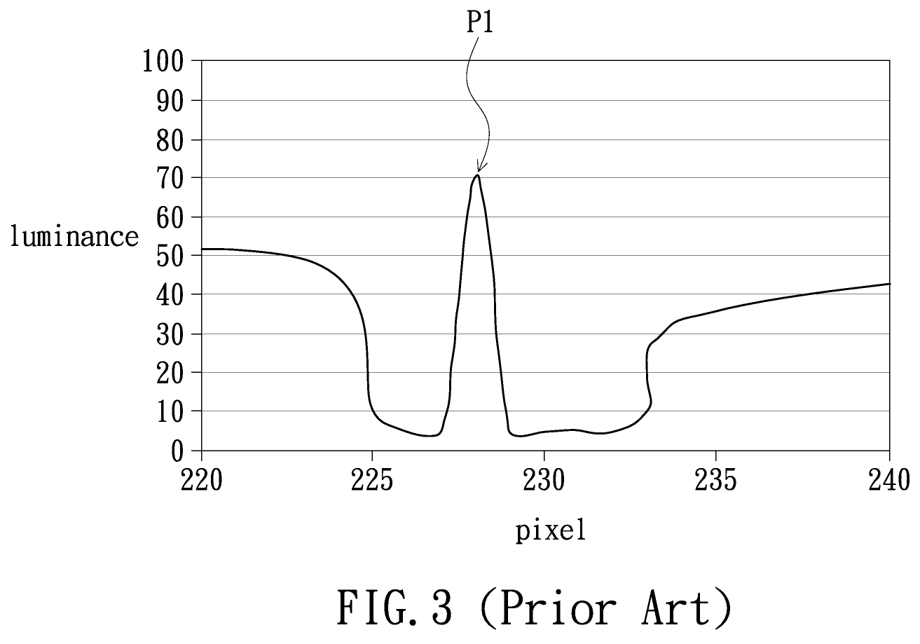

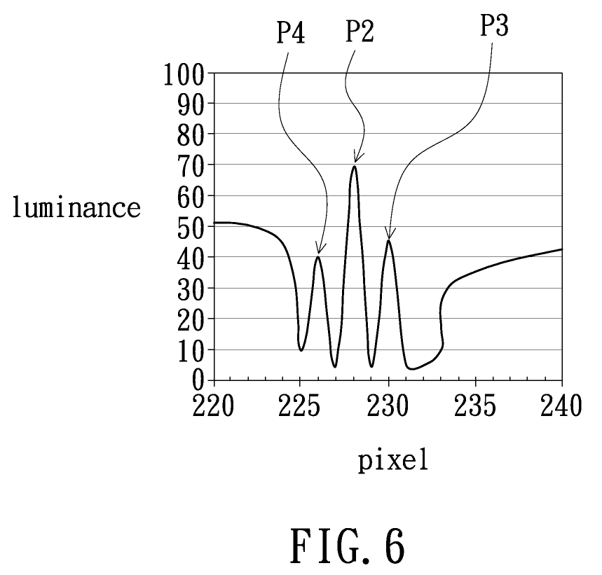

In this embodiment, because the optical cover 232 is arranged in the light emitting assembly 230b and the optical cover 232 includes the reflection part 235, not only the light L (indicated by solid lines) having a relatively small light emission angle (an angle between the emission direction of the light L and the optical axis C of the light emitting device 231, and for example 0˜45 degrees) can be directly emitted into the sensing region 210, the light L (indicated by dotted lines) having a relatively large light emission angle (for example, greater than 45 degrees) can also be reflected into the sensing region 210 through the reflection part 235 and thereby being sensed by the light sensor device 220a. As such, some pixels (specifically, corresponding to corner 212) of the light sensor device 220a can sense a luminance as illustrated in FIG. 6. As shown, compared with FIG. 3 in prior art, the luminance, beside the peak P2 which is resulted from the light L having a relatively small light emission angle, further has peaks P3, P4 which are resulted from the light L having a relatively large light emission angle; and accordingly, the dark areas associated with the peaks P2, P3 and P4 each can decrease effectively. Thus, the dark areas with a relatively small width can be prevented from being determined as a user's touch operation.

Similarly, due to having a structure same as the light emitting assembly 230b has, the dark areas resulted from the light emitted from the light emitting assembly 230a while the light sensor device 220b performing the light sensing operation can also have a relatively small size and accordingly can be prevented from being determined as a user's touch operation. Therefore, the optical touch apparatus 200 in this embodiment can effectively reduce the probability of erroneous touch position determinations.

It is to be noted that the present invention is not limited to the structure of the optical cover 232. For example, in another embodiment, the surfaces S1, S2 of light incidence part 233 each can be replaced by a curved surface and the surfaces S3, S4 of light emission part 234 each can be replaced by another curved surface. In addition, a portion of light L is emitted out from the surface S4 as illustrated in FIG. 5; however, to make the optical cover 232 have a reduced light emission angle, it is to be noted that the surface S4 can be coated with reflective materials so as to prevent the light L from being emitted out from the surface S4.

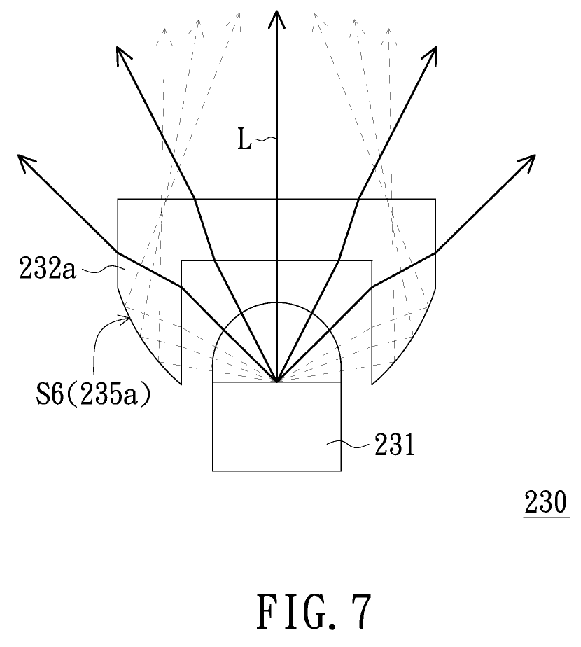

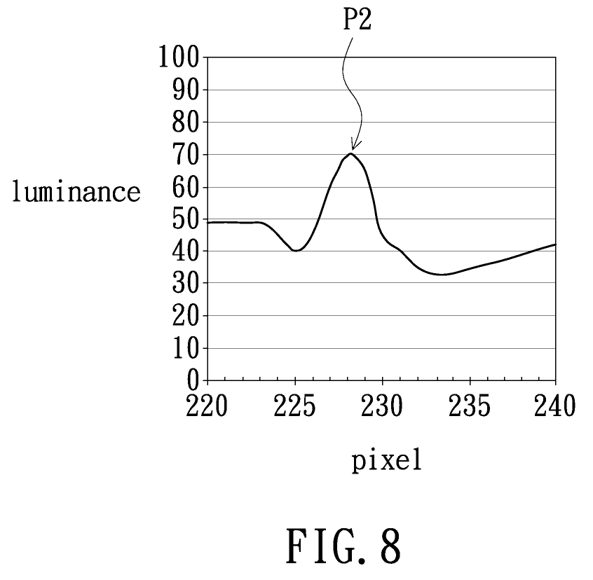

Moreover, in order to eliminate the dark areas more effectively, the reflective surface S5 of the reflection part 235 can be a curved surface with a specific structure, such as a non-spherical surface, a parabolic surface or a portion of an oval surface. FIG. 7 is a schematic top view of a light emitting assembly in accordance with another embodiment. As shown, the light emitting assembly 230 in this embodiment has a structure similar to that of the light emitting assembly shown in FIG. 5; and the main difference between the two is in the optical cover. Specifically, the reflective surface S6 of the reflection part 235a of the optical cover 232a is a cured surface with a specific structure, such as a non-spherical surface, a parabolic surface or a portion of an oval surface. Thus, some pixels (specifically, corresponding to the corner 212) of the light sensor device 220a (FIG. 4) can sense an luminance as illustrated in FIG. 8 if the light emitting assemblies 230a, 230b in the optical touch apparatus 200 each are replaced by the light emitting assembly 230. As illustrated in FIG. 8, the dark area(s) can be eliminated effectively by the light reflected from the reflective surface S6 and only the peak P2, which is resulted from the light L having a relatively small light emission angle, is left. Accordingly, the touch points can be determined more accurately.

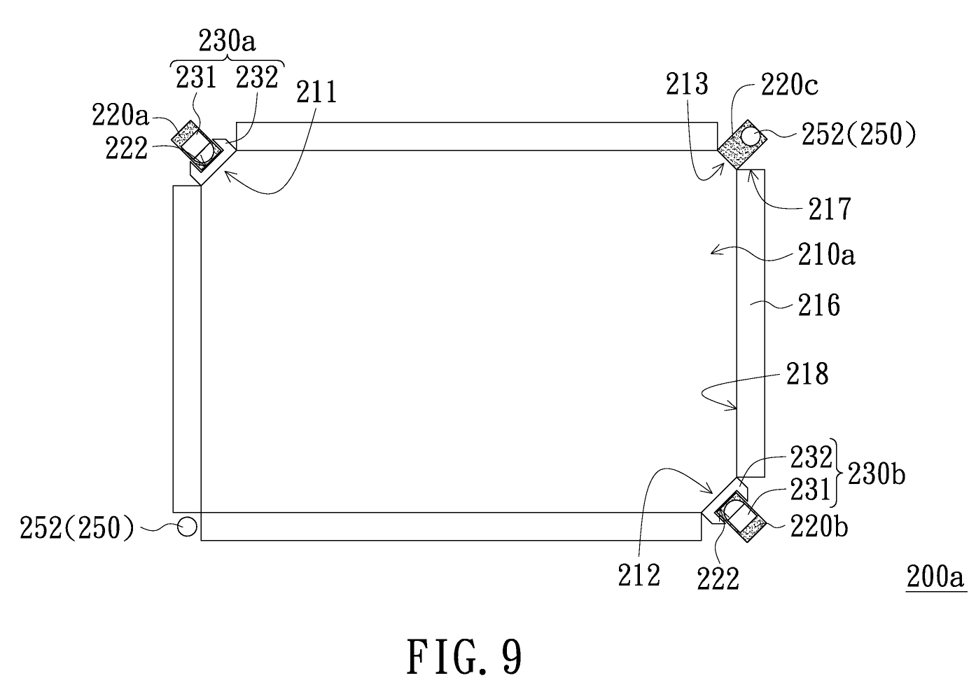

The optical touch apparatus 200 is exemplified by having a structure constituted by the reflective strips 214; however, it is to be noted the optical touch apparatus in another embodiment can have a light guide strip structure. FIG. 9 is a schematic structural view of an optical touch apparatus in accordance with another embodiment of the present invention. As shown, the optical touch apparatus 200a has a structure similar to that of the optical touch apparatus 200 in FIG. 4; and the main difference between the two is that the optical touch apparatus 200a has a light guide strip structure. Specifically, the sensing region 210a of the optical touch apparatus 200a includes a plurality of light guide strips 216 corporately forming the sides of the sensing region 210a. The light guide strips 216 each have a light incidence surface 217 and a light emission surface 218; wherein the light incidence surface 217 and the light emission surface 218 are arranged to be adjacent to each other, and the light emission surface 218 is arranged to face to the sensing region 210a. In addition, the optical touch apparatus 200a may further include a light source assembly 250 configured to provide light through a light emitting device 252 thereof; and the light emitted from the light emitting device 252 is firstly emitted into the light guide strip 216 through the light incidence surface 217 thereof, and then emitted into the sensing region 210a through the light emission surface 218 of the light guide strip 216. As shown, the light source assembly 250 in this embodiment is exemplified by including two light emitting devices 252; however, it is to be noted that the present invention is not limited to the number of the light emitting devices 252.

Similar to the optical touch apparatus 200 shown in FIG. 4, the optical touch apparatus 200a in this embodiment can also effectively prevent the touch positions from being erroneously determined.

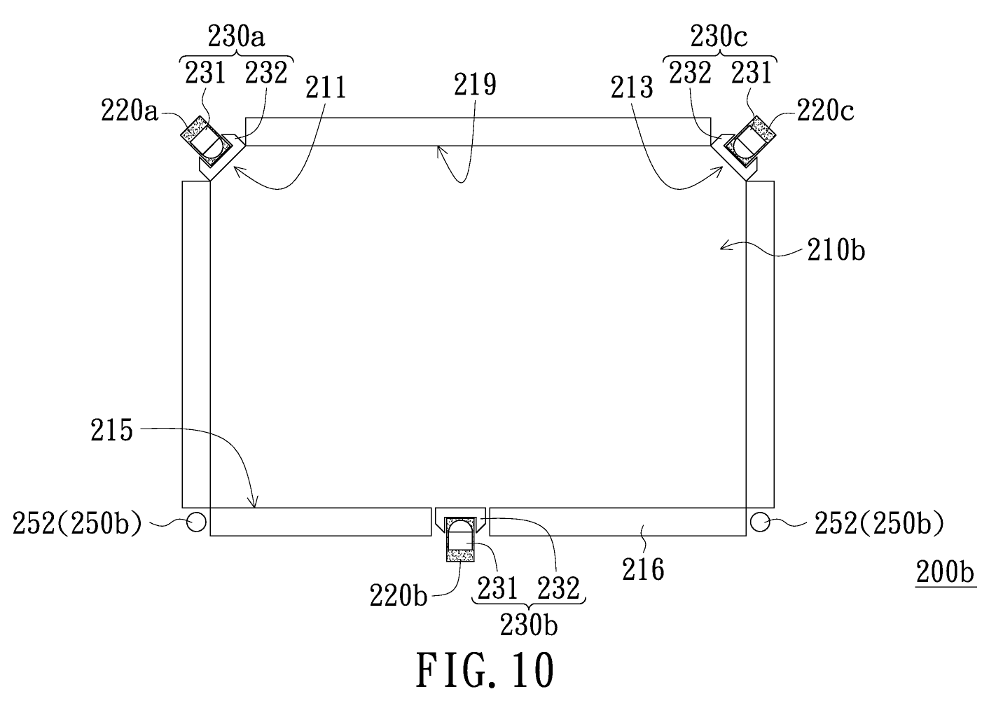

FIG. 10 is a schematic structural view of an optical touch apparatus in accordance with another embodiment of the present invention. As shown, in an optical touch apparatus 200b according to this embodiment, the light emitting assembly 230a is disposed at a corner 211 of the sensing region 210b and the light emitting assembly 230b is disposed at a side 215 (the one not adjacent to the corner 211) of the sensing region 210b. For example, the light emitting assembly 230b is disposed between the two ends of the side 215; and more specifically, the light emitting assembly 230b is disposed at a center position of the side 215. As such, the side 215 includes two light guide strips 216, and the light emitting assembly 230b is disposed in a gap formed between the aforementioned two light guide strips 216. In addition, the light emitting device 252 of the light source assembly 250b is configured to provide light into the light guide strips 216. Moreover, it is understood that the present invention is not limited to the number and position of the light emitting devices 252.

In addition, the optical touch apparatus 200b may further include another light emitting assembly 230c and a light sensor device 220c, which are disposed at a corner 213 of the sensing region 210b; wherein the corners 211, 213 are located respectively at two ends of the side 219 of the sensing region 210b. The light emitting assembly 230c has a structure same as that of the light emitting assembly 230a, and accordingly the light emitting assembly 230c includes a light emitting device 231 and an optical cover 232; wherein the light emitting device 231 of the light emitting assembly 230c and the light sensor device 220c are arranged to overlay to each other.

Similar to the optical touch apparatus 200 shown in FIG. 4, the optical touch apparatus 200b in this embodiment can also effectively prevent the touch positions from being erroneously determined. Additionally, in another embodiment, the light guide strips 216 in FIG. 10 can be replaced with reflective strips so that the light source assemblies 250b can be omitted.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch apparatus, comprising:
a sensing region;
a first light emitting assembly disposed in an edge area of the sensing region;
a second light emitting assembly disposed in an edge area of the sensing region, wherein the first and the second light emitting assemblies each comprise a light emitting device and an optical cover, the optical cover comprises a light incidence part, a light emission part and a reflection part, an accommodation space is defined by the light incidence part and configured to accommodate the light emitting device, the light provided by the light emitting device is sequentially emitted into the optical cover through the light incidence part thereof and emitted out from the optical cover through the light emission part thereof, the reflection part is disposed between the light incidence part and the light emission part and configured to reflect a portion of the light provided by the light emitting device;
a first light sensor device arranged to overlay the light emitting device of the first light emitting assembly; and
a second light sensor device arranged to overlay the light emitting device of the second light emitting assembly.

2. The optical touch apparatus according to claim 1, wherein the light incidence part has one first surface and two second surfaces, the second surfaces are arranged to be opposite to each other and both are connected to the first surface, the light emission part has one third surface, arranged to be opposite to the first surface, and two fourth surfaces, arranged to be opposite to the two second surfaces respectively, and the two fourth surfaces each are connected to the third surface, the reflection part has two reflective surfaces and each is connected between its associated second surface and the fourth surface.

3. The optical touch apparatus according to claim 2, wherein the second and the fourth surfaces are parallel to each other, the second surface is perpendicular to the first surface, the fourth surface is perpendicular to the third surface, the reflective surfaces each and its connected second surface are arranged to have an acute angle therebetween.

4. The optical touch apparatus according to claim 2, wherein the reflective surfaces each are a curved surface.

5. The optical touch apparatus according to claim 2, wherein the optical cover further comprises a reflective material coated on the fourth surfaces.

6. The optical touch apparatus according to claim 1, wherein the light incidence part and the light emission part each have a curved surface.

7. The optical touch apparatus according to claim 1, wherein the optical cover of the first light emitting assembly is further arranged to cover the first light sensor device, the optical cover of the second light emitting assembly is further arranged to cover the second light sensor device.

8. The optical touch apparatus according to claim 1, wherein the first light emitting assembly is disposed at a first corner of the sensing region, the second light emitting assembly is disposed at a second corner of the sensing region, the first and the second corners are located on a same diagonal line of the sensing region.

9. The optical touch apparatus according to claim 8, further comprising a third light sensor device disposed at a third corner of the sensing region.

10. The optical touch apparatus according to claim 1, wherein the sensing region comprises a plurality of reflective strips corporately forming a plurality of sides of the sensing region, the first and the second light emitting assemblies each are disposed in a gap formed between two adjacent reflective strips.

11. The optical touch apparatus according to claim 1, wherein the sensing region comprises a plurality of light guide strips corporately forming a plurality of sides of the sensing region, the first and the second light emitting assemblies each are disposed in a gap formed between two adjacent light guide strips, each light guide strip has a light incidence surface and a light emission surface, the light incidence surface and the light emission surface are arranged to be adjacent to each other and the light emission surface is arranged to face to the sensing region.

12. The optical touch apparatus according to claim 11, further comprising a light source assembly configured to provide the light emitted into the light guide strips through the light incidence surfaces thereof.

13. The optical touch apparatus according to claim 1, wherein the first light emitting assembly is disposed at a first corner of the sensing region, the second light emitting assembly is disposed at a side of the sensing region not adjacent to the first corner.

14. The optical touch apparatus according to claim 13, further comprising:
a third light emitting assembly disposed at a second corner of the sensing region, wherein the first and the second corners are located at two ends of a same side of the sensing region respectively, the third light emitting assembly has a structure same as that of the first light emitting assembly; and
a third light sensor device arranged to overlay the light emitting device of the third light emitting assembly.

15. The optical touch apparatus according to claim 1, further comprising a substrate, on which the sensing region is disposed.

16. The optical touch apparatus according to claim 15, wherein the substrate is a display panel.

17. An optical sensor module applicable to an optical touch apparatus, the optical sensor module comprising:
a light emitting assembly comprising a light emitting device and an optical cover, wherein the optical cover comprises a light incidence part, a light emission part and a reflection part, an accommodation space is defined by the light incidence part and configured to accommodate the light emitting device, the light provided by the light emitting device is sequentially emitted into the optical cover through the light incidence part thereof and emitted out from the optical cover through the light emission part thereof, the reflection part is connected between the light incidence part and the light emission part and configured to reflect a portion of the light provided by the light emitting device; and
a light sensor device arranged to overlay the light emitting device.
